(19) United States
(12) Patent Application Publication
(10) Pub. No.: US 2022/0358609 A1
(43) Pub. Date: Nov. 10, 2022

(54) Non-Fungible Token Based System for Litigation and Legal Matters

(71) Applicant: DASH4Law, Inc., Nashville, TN (US)

(72) Inventors: Larry Bridgesmith, Nashville, TN (US); Adel ElMessiry, Brentwood, TN (US)

(73) Assignee: DASH4Law, Inc., Nashville, TN (US)

(21) Appl. No.: 17/740,326

(22) Filed: May 9, 2022

Related U.S. Application Data
(60) Provisional application No. 63/185,911, filed on May 7, 2021.

(51) Int. Cl. G06Q 50/18; G06Q 20/12

(52) U.S. Cl. CPC G06Q 50/18; G06Q 20/1235; G06Q 2220/00

(57) ABSTRACT

The invention relates to an NFT based system of legal representation, including unique NFTs, oracles, and smart contracts for the management of legal matters, disposition of rights, and incentivizing of responsibilities.

### CROSS-REFERENCE TO RELATED APPLICATIONS

This application claims the benefit of U.S. Provisional Patent Application No. 63/185,911, filed on May 7, 2021,and entitled Platform and Method for a Legal Non-Fungible Token Based System, which is incorporated herein by reference in its entirety.

### BACKGROUND OF THE INVENTION

### Field of the Invention

The present invention is directed generally to a non-fungible token (NFT) system, and more particularly to an NFT system that may be used in financing litigation and forming interests, engagements and relationships in legal matters.

### Technology in the Field of the Invention

There is a growing trend in litigation financing, where typically a third-party individual or firm advances capital to further the litigation in exchange for a share of profits in the event of a litigation award. From July 2018 to July 2019, over $2.3 billion was invested by litigation financiers, mostly to large law firms. For an overview of litigation financing, see the Bloomberg Law article, “How Litigation Works,” incorporated here in its entirety and found at https://pro.bloomberglaw.com/brief/how-litigation-finance-works/.

The returns in litigation financing can be significant. In 2010, for instance, a company financing Ground Zero injury claims made an $11 million profit on a $35 million investment. In many cases, the funders are using sophisticated algorithms to decide whether a litigation is worthy of investment, based on factors such as a judge's past history and workload. For examples of recent financings and predictive algorithms, see the New Yorker article, “What Litigation Financing is Really About,” incorporated here in its entirety and found at https://www.newyorker.com/business/currency/what-litigation-finance-is-really-about.

While litigation financing is not new, it usually involves a 1:1 relationship, with a single firm financing a single litigation. What has largely been overlooked is the potential for crowdfunding litigation, in which multiple parties could fund through donation or invest through financing in a particular litigation in parallel. For an overview of crowdfunding litigation, see the Bloomberg Law article, “INSIGHT: Enriching Litigation Financing through Crowdfunding,” incorporated here in its entirety and found at https://news.bloomberglaw.com/us-law-week/insight-enriching-litigation-finance-through-crowdfunding. For an empirical analysis of the success metrics of litigation crowdfunding by donation, as opposed to investment, see the PLoS One study, “Understanding the Nature and Dimensions of Litigation Crowdfunding: A Visual Analytics Approach,” incorporated here in its entirety and found at https://www.ncbi.nlm.nih.gov/pmc/articles/PMC8078819/.

Litigation financing for return of profit (e.g., by a single investor) and litigation financing for cause (e.g., by a crowdfunding platform) both can benefit from technology that allows for a visible, tradable, asset and/or right, such as an NFT.

An NFT, in the most basic sense, is a unique unit of data that can be stored on a blockchain and attached to a digital file. The market for trading of NFTs for investment purposes rose from $82 million in 2020 to $17 billion in 2021. Applicant cites and incorporates the Wikipedia page “Non-fungible token” herein in its entirety, as presented on May 7, 2022: https://en.wikipedia.org/wikiNon-fungible_token.

Companies like Liti Capital have tokenized their own firm to issue equity to individual investors. Whereas Liti Capital maintains a direct relationship and investment position with a litigation claimant, investors can essentially purchase investor positions in Liti through the tokens $LITI and $wLITI. The company LawCoin Inc. has taken a similar approach by allowing investors to invest in select litigations through tokenization of LawCoin Investments, LLC.

In October 2021, the crowdfunding platform Republic attempted a crowdfunded, tokenized investment in a specific litigation that ultimately fell far short of the $5 million sought. For a summary of the offering, see https://republic.com/apothio#, incorporated here in its entirety.

NFT Tokenization of litigation, as opposed to NFT tokenized crowdsourcing of investment into litigation finance firms, is quite new. Consequently, there is a need for innovative processes and systems specific to legal representation that create market opportunities within the limitations of legal representation rules administered in various states.

### BRIEF SUMMARY OF THE INVENTION

In a first exemplary embodiment, an NFT is proposed and issued by an attorney or law firm directly to a potential client. The NFT is created by an attorney utilizing his or her status as an authenticated legal resource. The client then purchases the NFT to initiate the representation. The consideration presented by the client for the NFT, e.g. in the form of U.S. Dollars, is deposited into an escrow account. A smart contract governs the transfer of the consideration from the escrow account to the attorney according to one or more triggering events, e.g. the filing of a case, the execution of a settlement agreement, the issuance of a patent. The smart contract may further serve to issue damages to the client, e.g. if an injury award is deposited into an escrow account and a smart contract is pre-defined to issue a portion of the funds to the attorney as contingency fee and a portion of the funds to the client as damages.

In another exemplary embodiment, an NFT is issued by an attorney and made available for one or more third parties to purchase. The NFT is similarly tied to an escrow account for distribution to the representing attorney. Here, a collection of third parties may crowdfund an expectation interest in a portion of the award. For instance, a group of one hundred (100) investors could collectively invest five hundred thousand Dollars ($500,000) for an NFT that represents an expectation of twenty percent (20%) of a damages award. The collection of third parties may also wish not for monetary gain but for an NFT identifying their support of an important litigation, e.g. a civil rights litigation. The NFT may have valuable historical significance or personal significance. The NFT may also have regulatory significance, e.g. if a corporation invests in a litigation whose token is used to meet a regulatory standard, e.g. an ESG standard.

In another exemplary embodiment, an NFT is issued by an attorney and made available for one or more third parties to purchase. In this embodiment, the underlying legal matter may result in a traceable right that produces return on investment, e.g. a patent. In the present embodiment the NFT purchasers thus receive a right to future royalties or damages earned from the patent.

In another exemplary embodiment, an NFT is created for an estate plan. Upon death, a smart contract releases funds to an attorney for the supervision of estate administration, with passing rights or property flowing to an heir or holder of an NFT by virtue of the NFT. The NFT thus acts as a transparent and publicly accessible right that can be collateralized.

### BRIEF DESCRIPTION OF THE DRAWINGS

Embodiments of the present invention are better understood from the following detailed description with reference to the following drawings:

FIG. 1 is a diagram showing an NFT transaction between an attorney or NFT issuer and a single client.

FIG. 2 is a diagram showing an NFT transaction among an attorney or NFT issuer, third-party supporter, and client in which the client is issued the NFT.

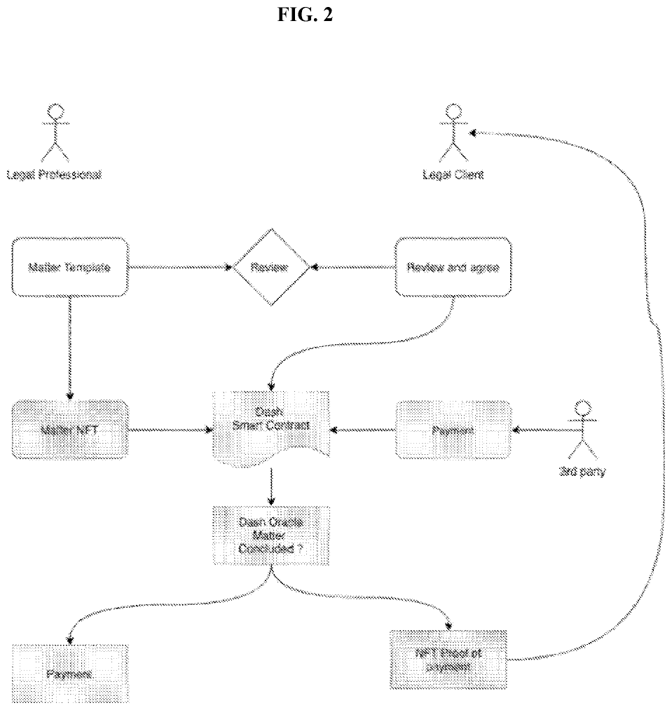

FIG. 3 is a diagram showing an NFT transaction among an attorney or NFT issuer, third-party investor, and client in which the investor is issued the NFT.

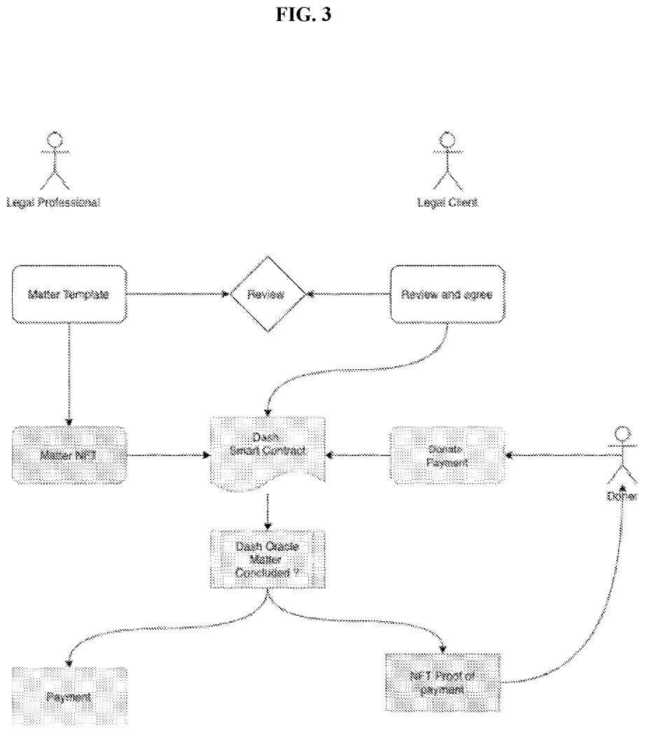

FIG. 4 is a diagram showing an NFT transaction among an attorney or NFT issuer, third-party supporter, and client in which the investor is issued the NFT and an additional royalty function is incorporated.

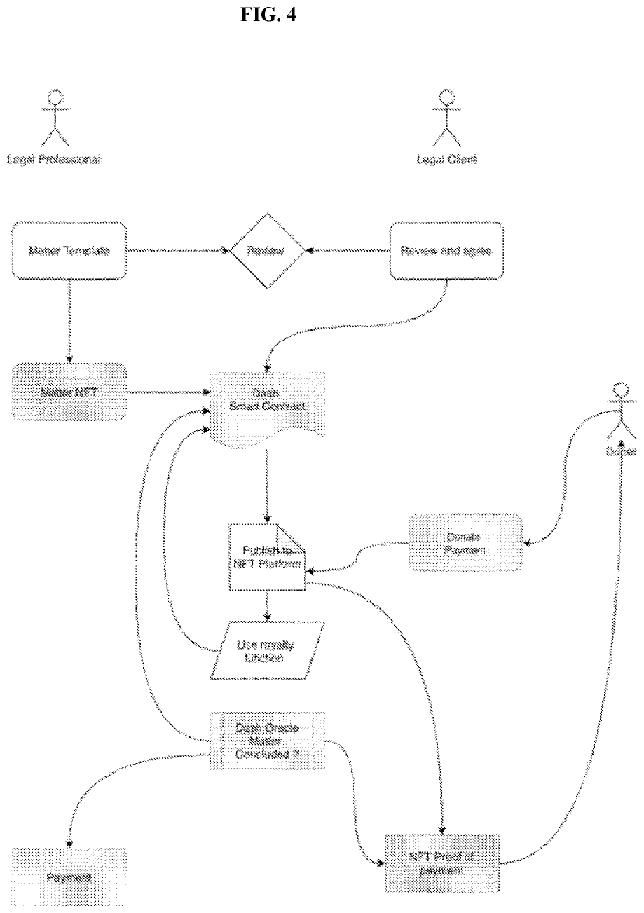

FIG. 5 is a diagram showing an NFT transaction among an attorney or NFT issuer, third-party investor, and client in which the investor is issued the NFT and a contractual damages right is issued to the client.

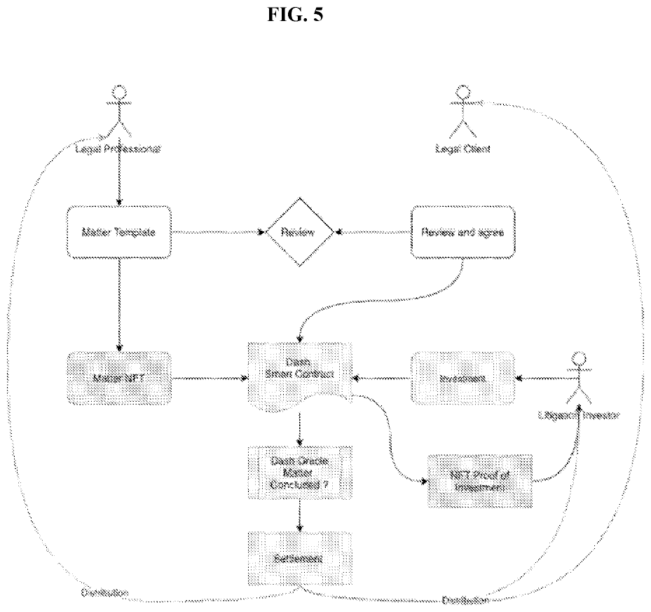

### DETAILED DESCRIPTION OF CERTAIN EMBODIMENTS

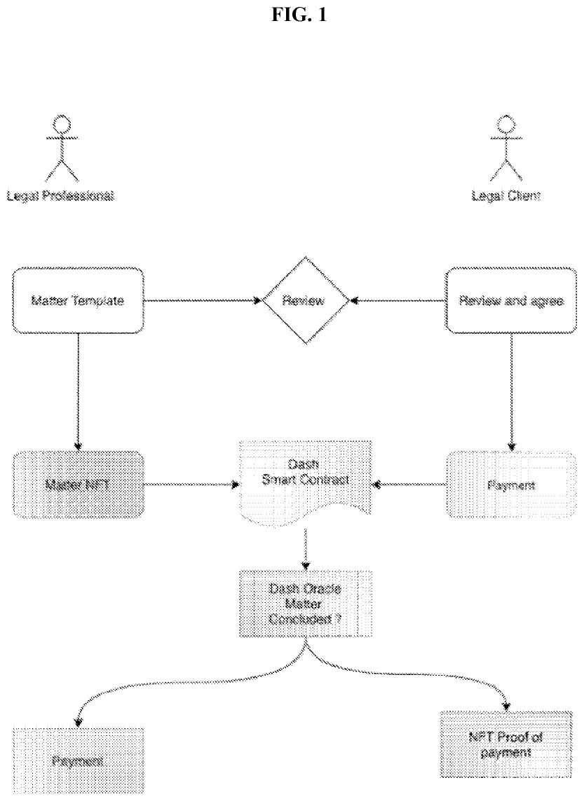

As depicted in FIG. 1, an exemplary embodiment of the NFT system displays a representation of a “Legal Professional” on the upper left side of the page. The Legal Professional here constitutes not necessarily an attorney, but rather someone who is authorized to issue an NFT based on a combination of a particular representing attorney and client, plus one or more of substantive matter, presiding judge, forum, damages potential, return on investment potential, defendant, case history, nature of injury, protectable technology, protectable source identifier, estate interest, and/or any other expectation that is usually derived through legal representation. The cells depicted under the Legal Professional are actions that may be performed by the Legal Professional or rights that accrue to the Legal Professional.

This first embodiment displays at the top right a “Legal Client.” While the Legal Client is most often the individual or entity that is seeking redress of an injury, enforcement or registration of a right, the Legal Client may be a person or entity to whom the redress or right is assigned or bequeathed. The cells depicted under the Legal Client are actions that may be performed by the Legal Client or rights that accrue to the Legal Client.

In a first exemplary embodiment illustrated in FIG. 1, a Legal Professional and Legal Client meet and confer about potential legal representation in most but not all cases to redress an injury, enforce or register a right. Upon conferring, the Legal Professional issues creates an NFT that is unique to the potential representation sought by the Legal Client. The Legal Client may purchase the rights to the NFT with consideration such as but not limited to cash currency. This currency is placed in an escrow account to be used by the Legal Professional or returned to the Legal Client.

While the NFT is authoritative evidence of the legal representation, the Legal Professional, and Legal Client, various aspects of the legal representation by the Legal Professional and management of the legal case are governed by a “Dash Smart Contract” executed between the parties. A Smart Contract is any computer program or transaction protocol which is intended to automatically execute, control or document legally relevant events and actions according to the terms of a contract or an agreement. The Smart Contract in this case may be authored by the Legal Professional or provided as a template or service by a third party, or an accessory to an existing escrow account. The Smart Contract between the parties may include triggering events where for example money is released from escrow to one of the parties, further funds are deposited, or representation is concluded. Any number of triggering events, conditions, payment, representation or case management terms may be included in a Smart Contract.

In connection with a Smart Contract a blockchain “Dash Oracle” may be employed to inform the Smart Contract of real-world events that may implicate one of the triggering events captured within the Smart Contract. Examples of information that Oracle might obtain include but are not limited to issuance of a patent or summary judgment.

In the exemplary embodiment of FIG. 1, upon certain triggering events identified in the Smart Contract, the parties may conclude their legal relationship with Legal Professional receiving payment or other consideration based on his/her/its role in the matter, and the Legal Client receiving his/her interest that is verifiable with the previously issued NFT.

We claim:

1) A system for transacting rights and responsibilities in a legal relationship between an attorney and client, comprising:
a medium for establishing mutual interests between an attorney and client;
a mechanism for minting an NFT in which initial transactional value is influenced by and descriptors of the NFT that are fixed in a blockchain include identities of attorney and client and one or more of substantive matter, presiding judge, forum, damages potential, return on investment potential, defendant, case history, nature of injury, protectable technology, protectable source identifier, and estate interest;
a means of exchanging by purchase said NFT with consideration;
a smart contract governing rights and responsibilities between the parties; and,
a blockchain oracle for informing the smart contract of triggering events.
